(19) United States
(12) Patent Application Publication
(10) Pub. No.: US 2024/0384098 A1
(43) Pub. Date: Nov. 21, 2024

(54) RESIN COMPOSITION FOR MOLDING, AND METHOD FOR MANUFACTURING MOLDED ARTICLE USING THE SAME

(71) Applicants: HYUNDAI MOTOR COMPANY, SEOUL (KR); KIA CORPORATION, SEOUL (KR); HYUNDAI WIA CORPORATION, CHANGWON-SI (KR); COAVIS, SEJONG-SI (KR)

(72) Inventors: Hyeong Won Park, Hwaseong-si (KR); Soon Beom Kwon, Yongin-si (KR); Seung Hun Choi, Suwon-si (KR); Seo Young Oh, Hwaseong-si (KR); Min Gyun Chung, Seoul (KR); Seung Ik Jang, Gwangmyeong-si (KR); Joo Sung Kim, Seoul (KR); Jong Bok Lee, Daejeon (KR); Tae Woong Youn, Cheongju-si (KR); Keon Sik Lee, Anyang-si (KR); Hyung Min Kim, Sejong-si (KR)

(21) Appl. No.: 18/590,018

(22) Filed: Feb. 28, 2024

(30) Foreign Application Priority Data
May 15, 2023 (KR) 10-2023-0062638
Aug. 18, 2023 (KR) 10-2023-0108576

(51) Int. Cl. C08L 81/04; C08J 5/04; C08K 7/14

(52) U.S. Cl. CPC C08L 81/04; C08J 5/043; C08K 7/14; C08J 2381/04; C08K 2201/003; C08K 2201/004; C08L 2205/08

(57) ABSTRACT

A resin composition for molding includes a polyarylene thioether resin having a constant α of 0.8 or greater determined by the Mark-Houwink equation represented by Equation 1: η=K×M^{α}. In Equation 1, η is the intrinsic viscosity, M is the molecular weight, and K and α are constants.

### CROSS REFERENCE TO RELATED APPLICATIONS

This application claims the priority of Korean Patent Application Nos. 10-2023-0062638 filed on May 15, 2023, and 10-2023-0108576 filed on Aug. 18, 2023, in the Korean Intellectual Property Office, the disclosure of which is incorporated herein by reference.

### BACKGROUND

### Field

The present disclosure relates to a resin composition for molding including a polyarylene thioether resin, and a method for manufacturing a molded article using the same.

### Description of the Related Art

Various parts, such as electronic parts, mechanical parts, and automobile parts, may be manufactured in the form of molded articles in which different molded bodies are combined. Typically, coupling parts (e.g., bolts, O-rings, and the like) were used to couple different molded bodies. However, when the coupling parts are used, a process of assembling products is complicated and manufacturing costs rise.

To address these issues, a method for manufacturing molded articles by coupling molded bodies using laser welding has been proposed. The laser welding is a method of overlapping a light-transmitting molded body and a light-absorbing molded body and then emitting a laser to the light-absorbing molded body through the light-transmitting molded body. In this case, heat is generated from the light-absorbing molded body by the laser emitted to the light-absorbing molded body, and this melts the light-transmitting molded body overlapping the light-absorbing molded body, and thus, the light-transmitting molded body and the light-absorbing molded body may be combined. When the laser welding is used, coupling parts may not be required, and accordingly, the economic feasibility and efficiency of a process of manufacturing products may be improved.

Meanwhile, products that are frequently exposed to high temperatures or external shocks (e.g., cooling system parts of automobiles such as water pumps) are required to have improved properties in heat resistance, chemical resistance, mechanical properties, and dimensional stability for greater reliability. In the manufacture of such products through the laser welding described above, the products are easily damaged when each of the light-transmitting molded body and the light-absorbing molded body fails to obtain the improved properties described above.

To prevent the issue described above, a method of forming a light-transmitting molded body and a light-absorbing molded body using a material typically known to have improved properties (e.g., polyarylene thioether resin, and the like) may be considered. However, especially as for the light-transmitting molded body, laser transmittance may not be sufficiently achieved when the materials described above are applied. When that happens, the light-transmitting molded body is not capable of sufficiently transmitting the laser upon the laser welding, and therefore, the laser may not be sufficiently emitted to the light-absorbing molded body. Accordingly, sufficient heat may not be generated from the light-transmitting molded body, so the light-transmitting molded body may not be melted, and the light-transmitting molded body and the light-absorbing molded body may not be combined.

### SUMMARY

An aspect of the present disclosure provides a resin composition for molding in which a molded body has improved heat resistance, chemical resistance, mechanical properties, and dimensional stability and a laser transmittance required for laser welding is sufficiently obtained, and a method for manufacturing a molded article using the same.

According to an aspect of the present disclosure, there is provided a resin composition for molding including a polyarylene thioether resin having a constant α of 0.8 or greater determined by the Mark-Houwink equation represented by Equation 1 below:

η=K×M^{α} Equation 1:

In Equation 1 above, η is the intrinsic viscosity, M is the molecular weight, and K and a are constants.

According to another aspect of the present disclosure, there is provided a method for manufacturing a molded article using the resin composition for molding.

### DETAILED DESCRIPTION

Hereinafter, a resin composition for molding and a method for manufacturing a molded article using the same will be described in detail so that the present disclosure may be easily carried out by a person skill in the art to which the present disclosure pertains.

### Resin Composition for Molding

A resin composition for molding of the present disclosure includes a polyarylene thioether resin.

The polyarylene thioether resin may have improved heat resistance, improved chemical resistance, improved mechanical properties, and improved dimensional stability, and accordingly, a molded body manufactured from a composition containing the polyarylene thioether resin may also have improved properties derived from the polyarylene thioether resin.

In addition, the polyarylene thioether resin may have sufficient linearity, and thus, a molded body manufactured from a composition containing the polyarylene thioether resin may obtain sufficient transmittance for a laser.

In detail, the polyarylene thioether resin may have a constant α of 0.8 or greater determined by the Mark-Houwink equation represented by Equation 1 below. In this case, the constant α indicates a value that shows the degree of branching of a polymer resin, and it is considered that the closer the constant α is to 1, the higher the linearity of the polymer resin is, and the closer the constant α is to 0, the higher the degree of branching of the polymer resin is.

η=K×M^{α} Equation 1:

In Equation 1 above, η is the intrinsic viscosity, M is the molecular weight, and K and a are constants.

The polyarylene thioether resin may have an intrinsic viscosity (η) of 1000 to 9000 poise; 2000 to 6000 poise; 2300 to 4800 poise; or 2700 to 4600 poise as measured by a method of ISO11443 (400s⁻¹). When the intrinsic viscosity (η) of the polyarylene thioether resin satisfies the above-described range, the polyarylene thioether resin may obtain improved heat resistance, improved chemical resistance, improved mechanical properties, and improved dimensional stability, and also have sufficient ease of molding.

The polyarylene thioether resin may include a homopolymer or a copolymer polymer containing repeating units represented by Formula —(Ar—S)— as a main constituent unit, or a blend that is a mixture of these polymers (Ar is an arylene group). In this case, the inclusion as a main constituent unit indicates that the polymer may contain the repeating units represented by Formula —(Ar—S)— in an amount of 80 mol % or greater, 90 mol % or greater, 95 mol % or greater, or 99.9 mol % or greater, with respect to 100 mol % of the total repeating units of the polymer. The arylene group may be a divalent group derived from a monocyclic or polycyclic aromatic compound such as substituted or unsubstituted benzene, naphthalene, biphenyl, anthracene, or phenanthrene.

In an embodiment, the polyarylene thioether resin may be a first polyarylene thioether resin containing at least one selected from the group consisting of repeating units represented by Formulas 1a to 1c below. For example, the first polyarylene thioether resin may be a homopolymer including one repeating unit selected from the group consisting of repeating units represented by Formulas 1a to 1c below; a copolymer including two or more repeating units selected from the group consisting of repeating units represented by Formulas 1a to 1c below (e.g., alternating copolymer, block copolymer, or random copolymer); or a blend including at least two of these. When the first polyarylene thioether resin includes at least one of the repeating units described above, the first polyarylene thioether resin may have improved properties and sufficient linearity.

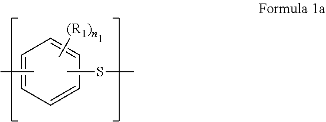

In Formula 1a above, R₁ is each independently H, a substituted or unsubstituted C₁ to C₄ alkyl group, or a phenyl group, and n₁ is an integer of 0 to 4.

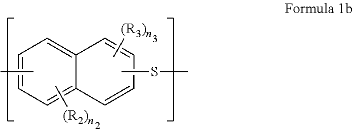

In Formula 1b above, R₂ and R₃ are each independently H or a substituted or unsubstituted C₁ to C₄ alkyl group, and n₂ and n₃ are each independently an integer of 0 to 3.

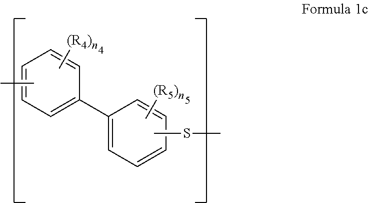

In Formula 1c above, R₄ and R₅ are each independently H or a substituted or unsubstituted C₁ to C₄ alkyl group, and n₄ and ns are each independently an integer of 0 to 4.

The term “substituted or unsubstituted” in each of Formula 1a, Formula 1b, and Formula 1c above may indicate, for example, that a hydrogen atom bonded to a carbon atom is substituted or unsubstituted with at least one substituent selected from the group consisting of a halogen group, a C₁ to C₃ alkyl group, a C₂ to C₃ alkenyl group, and a C₂ to C₃ alkynyl group. However, the substituents described above are presented as an example, and the embodiment of the present disclosure is not limited thereto. In detail, the substituents may be selected to achieve the purpose of further improving some properties in the range that satisfies the properties (e.g., heat resistance, chemical resistance, mechanical properties, dimensional stability, linearity, and the like) required for the polyarylene thioether resin in the present disclosure. Accordingly, various types of substituents may be appropriately selected to achieve this purpose without being limited to the examples described above.

In this case, preferably, the repeating unit of Formula 1a above may be represented by Formula 2a below, and more preferably, the first polyarylene thioether resin may be a polyphenylene sulfide (PPS) resin. In this case, the above-described improved properties and sufficient linearity may be achieved at a relatively low price, and thus manufacturing efficiency may be improved.

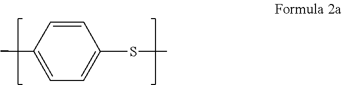

In an embodiment, the polyarylene thioether resin may include the first polyarylene thioether resin and/or a second polyarylene thioether resin that is a cross-linked product of the first polyarylene thioether resin. In this case, the second polyarylene thioether resin may have greater heat resistance, greater chemical resistance, greater mechanical properties, and greater dimensional stability than the first polyarylene thioether resin, and accordingly, the polyarylene thioether resin may have further improved heat resistance.

In the above-described embodiment, when the polyarylene thioether resin includes the second polyarylene thioether resin alone, the crosslinking density of the second polyarylene thioether resin may be appropriately selected in the range in which the Mark-Houwink equation constant α of the polyarylene thioether resin satisfies 0.8 or greater.

In addition, in the above-described embodiment, when the polyarylene thioether resin includes both the first polyarylene thioether resin and the second polyarylene thioether resin, the amount and/or the crosslinking density of the second polyarylene thioether resin may be appropriately selected in the range in which the Mark-Houwink equation constant α of the polyarylene thioether resin satisfies 0.8 or greater.

That is, only when sufficient linearity of the polyarylene thioether resin is obtained, the second polyarylene thioether resin may be included to further improve the heat resistance of the polyarylene thioether resin.

In an embodiment, the resin composition for molding may further include a fiber material. The fiber material may be added to improve moisture-heat resistance, acid resistance, alkali resistance, mechanical strength, and dimensional stability.

In an embodiment, the fiber material may include at least one selected from the group consisting of glass fiber, carbon fiber, graphite fiber, metal fiber, basalt fiber, cotton fiber, wool fiber, silk fiber, aramid fiber, polyacrylonitrile fiber, arylate fiber, polyetherketone fiber, nylon fiber, and polyarylene terephthalate fiber.

In an embodiment, the fiber material may be included in an amount of 10 to 70 parts by weight, 10 to 67 parts by weight, or 20 to 67 parts by weight, with respect to 100 parts by weight of the polyarylene thioether resin When the amount of the fiber material satisfies the above-described range, ease of molding may be improved, and excessive reduction in laser transmittance may not be caused.

In an embodiment, the fiber material may be in the form of chopped strands having a nominal diameter of 5 to 30 um and a length of 2 to 10 mm. When the nominal diameter of the fiber material satisfies the above-described range, the resin composition for molding may have improved overall mechanical strength, and also the dispersibility of the fiber material in the polyarylene thioether resin may be sufficiently achieved. In addition, when the length of the fiber material satisfies the above-described range, the resin composition for molding may have improved mechanical strength and sufficient ease of molding.

In an embodiment, the resin composition for molding may further include functional additives. The functional additives may include at least one selected from the group consisting of a compatibilizer, an impact resistance agent, a heat resistance agent, a surface modifier, an antioxidant, a wear resistance agent, an ultraviolet stabilizer, a neutralizer, a brightener, a flame retardant, a fluorescent whitening agent, a plasticizer, a thickener, an antistatic agent, a mold release agent, a pigment, and a nucleating agent. In this case, depending on the purpose of the additive added, the additives may serve to improve various performances. For example, the compatibilizer may serve to improve compatibility between the polyarylene thioether resin and the fiber material, the impact resistance agent may serve to improve impact performance, and the heat resistance agent may serve to improve heat resistance.

In an embodiment, the functional additives may be included in an amount of 0.01 to 8 parts by weight with respect to 100 parts by weight of the polyarylene thioether resin.

### Method for Manufacturing Molded Articles Using the Above-Described Molding Resin Composition

The method for manufacturing a molded article of the present disclosure includes welding a first molded body formed from the above-described resin composition for molding to a second light-absorbing molded body with a laser.

The first molded body may be formed from the resin composition for molding, and various known molding methods may be used to form the first molded body. For example, commonly used meltmixing methods and devices may be used to form the first molded body. The devices that may be used for the meltmixing may be, for example, a single-screw extruder or a twin-screw extruder. When the single-screw extruder or the twin-screw extruder is used, it is preferable to maximize the effect of uniform mixing by the shear force of the screw in the extruder by introducing the resin composition for molding containing a polyarylene sulfide resin through an inlet, and it is desirable to minimize the residence time in the extruder to reduce volatilization of additives and maximize the physical properties of the composition.

The first molded body formed from the resin composition for molding may have improved properties (e.g., improved heat resistance, improved chemical resistance, improved mechanical properties, and improved dimensional stability) derived from the polyarylene thioether resin included in the resin composition for molding and may also be provided with sufficient laser transmittance required for laser welding. For example, the first molded body may have a transmittance to the laser of at least about 10% or greater, preferably about 15% or greater.

The second molded body may be formed from a light-absorbing resin composition containing a thermoplastic resin and a light-absorbing dye, and various known molding methods may be used to form the second molded body. The second molded body may absorb the laser, and the second molded body may have a lower transmittance to the laser than the first molded body. Preferably, the second molded body may substantially completely absorb the laser and generate sufficient heat to melt the first molded body.

The welding of the first molded body to the second molded body with a laser may include overlapping the first molded body and the second molded body and then emitting the laser to the second molded body through the first molded body. In this case, heat is generated from the second molded body by the laser emitted to the second molded body, and this melts the first molded body overlapping the second molded body, and thus, the first molded body and the second molded body may be combined. In this case, the first molded body may be referred to as a light-transmitting molded body, and the second molded body may be referred to as a light-absorbing molded body.

Hereinafter, the present disclosure will be described in more detail through Examples. However, these Examples are provided to assist understanding of the present disclosure, and the scope of the present disclosure is not limited to the Examples in any sense.

### Example 1: Pellet Formed from Resin Composition for Molding

A polyphenylene sulfide (PPS) resin as a polyarylene thioether resin (the Mark-Houwink equation constant α is 0.950); glass fiber in the form of chopped strands having a nominal diameter of 11 μm and an average length of 4 mm; and a resin composition for molding containing functional additives (compatibilizer and impact resistant agent) (polyphenylene sulfide resin: glass fiber: functional additive=100:25:5 (weight ratio)) were extruded at a temperature of 290 to 330° C. in a twin-screw extruder (manufactured by Leistritz) to obtain pellets.

In this case, the Mark-Houwink equation constant α of the polyphenylene sulfide resin was measured using AresG2 Rheometer (manufactured by TA Instruments), and specifically, the polyphenylene sulfide resin was melted at 300° C. and then the viscosity was measured at a shear rate of 0.5 rad/s and 20 rad/s to quantify a decrease in viscosity based on the shear thinning phenomenon of the resin and calculate the linearity (linearity=viscosity [20 rad/s]/viscosity [0.5 rad/s]), thereby obtaining the Mark-Houwink equation constant a.

### Example 2: Pellet Formed from Resin Composition for Molding

A pellet was manufactured in the same manner as in Example 1, except that the amount of glass fiber included in the resin composition for molding was as shown in Table 1 below.

### Example 3: Pellet Formed from Resin Composition for Molding

A pellet was manufactured in the same manner as in Example 1, except that the amount of glass fiber included in the resin composition for molding was as shown in Table 1 below.

### Comparative Example 1: Pellet Formed from Resin Composition for Molding

A pellet was manufactured in the same manner as in Example 1, except that a polyphenylene sulfide resin having a Mark-Houwink equation constant α of 0.67 was used as the polyarylene thioether resin.

### Comparative Example 2: Pellet Formed from Resin Composition for Molding

A pellet was manufactured in the same manner as in Example 2, except that a polyphenylene sulfide resin having a Mark-Houwink equation constant α of 0.67 was used as the polyarylene thioether resin.

### Comparative Example 3: Pellet Formed from Resin Composition for Molding

A pellet was manufactured in the same manner as in Example 3, except that a polyphenylene sulfide resin having a Mark-Houwink equation constant α of 0.67 was used as the polyarylene thioether resin.

In Examples 1 to 3 and Comparative Examples 1 to 3, the Mark-Houwink equation constant α of the polyphenylene sulfide resin, and the weight ratio of the polyphenylene sulfide resin, the glass fiber (GF), and the functional additive were shown in Table 1 below.

TABLE 1

| | Mark- | Polyphenylene | GF | Functional |
|---|---|---|---|---|
| | Houwink | sulfide | (Parts | additive |
| | equation | resin | by | (Parts by |
| | constant α | (Parts by weight) | weight) | weight) |
| Example 1 | 0.950 | 100 | 25 | 5 |
| Example 2 | 0.950 | 100 | 43 | 5 |
| Example 3 | 0.950 | 100 | 67 | 5 |
| Comparative | 0.67 | 100 | 25 | 5 |
| Example 1 | | | | |
| Comparative | 0.67 | 100 | 43 | 5 |
| Example 2 | | | | |
| Comparative | 0.67 | 100 | 67 | 5 |
| Example 3 | | | | |

### Measurement Example 1: Measurement of Tensile Strength

The pellets of Examples 1 to 3 and Comparative Examples 1 to 3 were each manufactured into specimens to comply with ISO527 standards, and then the tensile strength was measured according to the method of ISO527, and the results are shown in Table 2 below.

### Measurement Example 2: Measurement of Flexural Strength

The pellets of Examples 1 to 3 and Comparative Examples 1 to 3 were each manufactured into specimens to comply with ISO178 standards, and then the flexural strength was measured according to the method of ISO178, and the results are shown in Table 2 below.

### Measurement Example 3: Measurement of Impact Strength

The pellets of Examples 1 to 3 and Comparative Examples 1 to 3 were each manufactured into specimens to comply with ISO180 standards, and then the impact strength was measured according to the method of ISO180, and the results are shown in Table 2 below.

### Measurement Example 4: Measurement of Heat Deflection Temperature

The pellets of Examples 1 to 3 and Comparative Examples 1 to 3 were each manufactured into specimens to comply with ISO75 standards, and then the flexural strength was measured according to the method of ISO75, and the results are shown in Table 2 below.

### Measurement Example 5: Measurement of Laser Transmittance and Carbonization

A 1 mm thick specimen was prepared using the pellets of Examples 1 to 3 and Comparative Examples 1 to 3, and then the specimen was irradiated with a laser using a Radiance model (manufactured by EMERSON/BRANSON Korea) to meet the following measurement conditions, thereby measuring laser transmittance and carbonization, and the results are shown in Table 2 below.
Measuring Conditions
Laser wavelength(nm): 980
Laser spot diameter(φ): 3.75
Power meter input diameter(φ): 20
Laser irradiation time (sec): 5
Standard laser power(W): 4.2

TABLE 2

| | | | | Heat | | |
|---|---|---|---|---|---|---|
| | Tensile | Flexural | Impact | deflection | Laser | Carbonization |
| | strength | strength | strength | temperature | transmittance | (Visual |
| | (MPa) | (MPa) | (KJ/m²) | (° C.) | (%) | observation) |
| Example 1 | 120 | 170 | 7 | 255 | 35 | X |
| Example 2 | 170 | 260 | 9 | 255 | 22 | X |
| Example 3 | 195 | 285 | 10 | 270 | 17 | X |
| Comparative | 130 | 200 | 8 | 255 | <5 (not | ◯ |
| Example 1 | | | | | measurable) | |
| Comparative | 171 | 270 | 11 | 255 | <5 (not | ◯ |
| Example 2 | | | | | measurable) | |
| Comparative | 200 | 300 | 11 | 260 | <5 (not | ◯ |
| Example 3 | | | | | measurable) | |

Referring to Table 2, it is determined that the specimens formed from the pellets of Examples 1 to 3 had a laser transmittance of about 15% or greater and were not carbonized by the laser. In contrast, it is determined that the specimens formed from the pellets of Comparative Examples 1 to 3 had a laser transmittance of less than about 5%, making accurate measurement unavailable, and were carbonized by the laser.

Meanwhile, it is determined that the tensile strength, flexural strength, impact strength, and heat deflection temperature of the specimens formed from the pellets of Examples 1 to 3 were at a similar level to the tensile strength, flexural strength, impact strength, and heat deflection temperature of the specimens formed from the pellets of Comparative Examples 1 to 3 (i.e., the difference is relatively small, at a level of 2 to 15%).

From the measurement results described above, it is seen that the specimens formed from the pellets of Examples 1 to 3 have outstanding laser transmittance and improved physical properties.

A molded body manufactured using a resin composition for molding of the present disclosure may have improved properties (e.g., improved heat resistance, improved chemical resistance, improved mechanical properties, and improved dimensional stability) derived from a polyarylene thioether resin, and a sufficient laser transmittance required for laser welding.

While the present disclosure has been shown and described in connection with the exemplary embodiments, it will be apparent to those skilled in the art that modifications and variations can be made without departing from the spirit and scope of the disclosure as defined by the appended claims.

1. A resin composition for molding comprising a polyarylene thioether resin having a constant α of 0.8 or greater determined by the Mark-Houwink equation represented by
η=K×M^{α} Equation 1:
wherein n is the intrinsic viscosity, M is the molecular weight, and K and a are constants.

2. The resin composition for molding of claim 1, wherein in Equation 1, the intrinsic viscosity (η) is 2700 to 4600 poise.

3. The resin composition for molding of claim 1, wherein the polyarylene thioether resin is a first polyarylene thioether resin comprising at least one selected from the group consisting of repeating units represented by Formulas 1a to 1c: 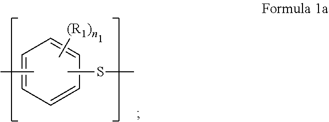
wherein R₁ is each independently H, a substituted or unsubstituted C₁ to C₄ alkyl group, or a phenyl group, and n₁ is an integer of 0 to 4; 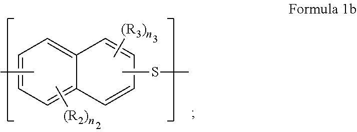
wherein, R₂ and R₃ are each independently H or a substituted or unsubstituted C₁ to C₄ alkyl group, and n₂ and n₃ are each independently an integer of 0 to 3; and 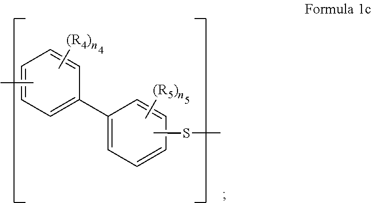
wherein R₄ and R₅ are each independently H or a substituted or unsubstituted C₁ to C₄ alkyl group, and n₄ and n₅ are each independently an integer of 0 to 4.

4. The resin composition for molding of claim 3, wherein the repeating unit of Formula 1a is represented by Formula 2a:

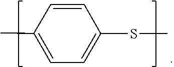

5. The resin composition for molding of claim 4, wherein the first polyarylene thioether resin is a polyphenylene sulfide (PPS) resin.

6. The resin composition for molding of claim 3, wherein the polyarylene thioether resin comprises the first polyarylene thioether resin, and a second polyarylene thioether resin that is a cross-linked product of the first polyarylene thioether resin.

7. The resin composition for molding of claim 1, further comprising a fiber material.

8. The resin composition for molding of claim 7, wherein the resin composition for molding comprises the fiber material in an amount of 10 to 70 parts by weight with respect to 100 parts by weight of the polyarylene thioether resin.

9. The resin composition for molding of claim 7, wherein the fiber material is in the form of chopped strands having a nominal diameter of 5 to 30 μm and a length of 2 to 10 mm.

10. The resin composition for molding of claim 7, wherein the fiber material comprises at least one selected from the group consisting of glass fiber, carbon fiber, graphite fiber, metal fiber, basalt fiber, cotton fiber, wool fiber, silk fiber, aramid fiber, polyacrylonitrile fiber, arylate fiber, polyetherketone fiber, nylon fiber, and polyarylene terephthalate fiber.

11. The resin composition for molding of claim 1, further comprising a functional additive.

12. The resin composition for molding of claim 11, wherein the functional additive comprises at least one selected from the group consisting of a compatibilizer, an impact resistance agent, a heat resistance agent, a surface modifier, an antioxidant, a wear resistance agent, an ultraviolet stabilizer, a neutralizer, a brightener, a flame retardant, a fluorescent whitening agent, a plasticizer, a thickener, an antistatic agent, a mold release agent, a pigment, and a nucleating agent.

13. The resin composition for molding of claim 11, wherein the resin composition for molding comprises the functional additive in an amount of 0.01 to 8 parts by weight with respect to 100 parts by weight of the polyarylene thioether resin.

14. A method for manufacturing a molded article, the method comprising welding a first molded body formed from a resin composition for molding comprising a polyarylene thioether resin having a constant α of 0.8 or greater determined by the Mark-Houwink equation represented by Equation 1: η=K×M^{α}, and a light-absorbing second molded body with a laser;
wherein η is the intrinsic viscosity, M is the molecular weight, and K and α are constants.

15. The method of claim 14, wherein in Equation 1, the intrinsic viscosity (η) is 2700 to 4600 poise.

16. The method of claim 14, wherein the polyarylene thioether resin is a first polyarylene thioether resin comprising at least one selected from the group consisting of repeating units represented by Formulas 1a to 1c: 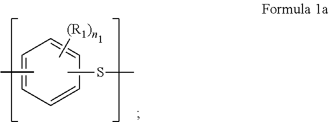
wherein R₁ is each independently H, a substituted or unsubstituted C₁ to C₄ alkyl group, or a phenyl group, and n1 is an integer of 0 to 4; 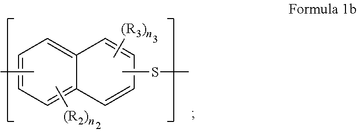
wherein R₂ and R₃ are each independently H or a substituted or unsubstituted C₁ to C₄ alkyl group, and n₂ and n₃ are each independently an integer of 0 to 3; and 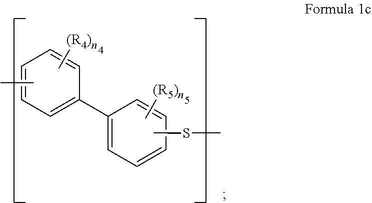
wherein R₄ and Rs are each independently H or a substituted or unsubstituted C₁ to C₄ alkyl group, and n₄ and ns are each independently an integer of 0 to 4.

17. The method of claim 16, wherein the repeating unit of Formula 1a is represented by Formula 2a:

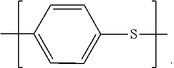

18. The method of claim 17, wherein the first polyarylene thioether resin is a polyphenylene sulfide (PPS) resin.

19. The method of claim 14, wherein a transmittance of the first molded body to the laser is greater than a transmittance of the second molded body to the laser.

20. The method of claim 14, wherein the laser is emitted to the second molded body through the first molded body.
